(19) United States
(12) Patent Application Publication
(10) Pub. No.: US 2025/0140433 A1
(43) Pub. Date: May 1, 2025

(54) SYSTEMS AND METHODS TO DYNAMICALLY CONFIGURE A COLLIMATOR APERTURE IN AN X-RAY CT IMAGING SYSTEM

(71) Applicant: GE Precision Healthcare LLC, Waukesha, WI (US)

(72) Inventors: Srinivasan Kannan, Bengaluru (IN); Ajay Narayanan, Bengaluru (IN)

(21) Appl. No.: 18/935,141

(22) Filed: Nov. 1, 2024

(30) Foreign Application Priority Data
Nov. 1, 2023 (IN) 202341074474

(51) Int. Cl. G21K 1/04; G01T 1/29

(52) U.S. Cl. CPC G21K 1/04; G01T 1/2985

(57) ABSTRACT

Various systems and methods are provided for a system and a computer-implemented method to dynamically configure a collimator aperture of a CT imaging system. The system may be provided to dynamically configure a collimator aperture over a slice coverage of a CT imaging system. The system may, further, provide a processor programmed to select an X-ray dose efficiency based on one or more parameters and dynamically configure a collimator aperture of the system within a reliability range of a calibration curve based on the selected X-ray dose efficiency and flux measured by the X-ray detector.

### CROSS-REFERENCE TO RELATED APPLICATIONS

This application claims priority to Indian Application No. 202341074474, filed on Nov. 1, 2023, the disclosure of which is incorporated herein by reference in its entirety.

### BACKGROUND

This disclosure generally relates to an imaging system and more particularly to a system and method for dynamic configuration of a collimator aperture of a pre-patient collimator of a computed tomography (CT) imaging system.

Various medical imaging systems and methods are used to obtain images of a subject for diagnosing a medical conditions of the subject. The medical imaging system may be for example, an X-ray system, a computed tomography (CT) imaging system, a magnetic resonance (MR) imaging system, a positron emission tomography (PET) imaging system, a single photon emission computed tomography (SPECT) imaging system, an ultrasound imaging system, or a multi-modality imaging system. These and other imaging systems are the most widely known and used for acquiring the image data of a subject and generate user viewable images of the subject.

Imaging a subject using the medical imaging system such as a computed tomography (CT) imaging system involves positioning the subject over the table, moving the table inside the gantry of the CT imaging system. In case of the CT imaging system, the X-rays may be passed in different directions through the subject body to obtain the images of the internal volume of the subject. The CT imaging system include an X-ray generator that powers the X-ray tube for emitting the X-rays on to the subject body positioned in the gantry and an X-ray detector is positioned to receive the X-rays. The X-rays received by the X-ray detector are processed using various image reconstruction and visualization techniques to generate a user viewable image of the subject. The CT imaging system utilizes a series of X-ray projections at different angles, taken axially through a slice or a thin cross-section area of the subject. The X-rays may get transmitted transversely through a portion of the patient's anatomy and then the attenuated X-rays may get detected by the X-ray detectors. Each projection may comprise a series of discrete samples of X-rays and attenuation coefficients may be determined, and image of the patient's anatomy may be reconstructed.

A CT imaging system may be a single-slice or a multi-slice. In the multi-slice CT imaging system, an anatomical region subjected to scanning may be much smaller than the maximum X-ray detection region commonly referred to as slice coverage. The process of controlling the amount of X-ray exposure within the slice coverage towards the active elements of the multi-slice X-ray detector is referred to as collimation. Given that X-ray is an ionizing radiation, there are variety of dose management techniques ranging from bowtie filtration, tube current (mA) modulation, tube voltage (kV) modulation used in conjunction with algorithmic statistical reconstruction techniques that may additionally include system model parameters to ensure desired image quality.

A multi-slice CT imaging system includes a pre-patient collimator to shape and calibrate the X-ray beam, and to track the X-ray beam in the z-direction. In an embodiment, X-ray beam position calibration method uses signal from the outer and inner rows to obtain calibration curves corresponding to different X-ray detector rows. In one embodiment, the method provides a plurality of calibration curves whereas in another embodiment the method chooses one calibration curve based on an optimality constraint.

Image quality may be one of the performance indicators of an imaging system. In CT imaging systems, image quality may be defined with the help of one or more quality metrics, which may include image noise, low contrast detectability, spatial resolution, and CT number uniformity. These quality metrics, together, define the clinical acceptability of an image generated out of the CT imaging system. There may be several clinical protocol scenarios and acceptability thresholds across a user community and hence multiple user settings to control the system exposure parameters that in-turn govern the image quality are provided to system users. Given the ionizing nature of X-rays, the underlying expectation of ALARA (As Low As Reasonably Achievable) dose at any given setting is the guiding design principle in any such system from the perspective of patient safety.

In a CT imaging system, the pre-patient collimator assembly includes independently movable cams that are configured to track the focal spot position and thereby more accurately position the X-ray beam on the active elements of the X-ray detector. Specifically, at least one known CT imaging system detects the X-ray beam profile on either one or on both ends of the X-ray detector and utilizes this information to adjust the cam positions. This ensures that most of the X-ray photons falling on the X-ray detector are utilized in image generation as per ALARA (as low as reasonably achievable) principle. In such an arrangement, the quality of the image obtainable from the outer most X-ray detector element depends on the proportion of the X-ray flux in relation to the flux at the central X-ray detector element. This depends on the width of the focal spot and the width of the X-ray beam falling on the active imaging X-ray detector elements.

A pre-patient collimator may be a device to control the slice coverage of the X-ray exposure. Conventionally, it has been employed to allow for various clinical scan coverage requirements. Existing knowledge provides systems and methods to block X-rays in a non-imaging region but nowhere discloses about controlling or modulating the dose of the X-ray with respect to the image quality within a CT scan.

The dose efficiency of the CT imaging system may be correlated to the image quality i.e., higher the dose efficiency, lower the X-ray flux. The pre-patient collimator may partially block an X-ray detector from receiving the X-rays and in turn this may have an impact on the measurement quality of the CT imaging system. While physics-based correction techniques may be routinely employed early in the signal processing chain prior to reconstruction of the image in imaging systems but such techniques may not be able to recover any non-linear losses owing to reduced X-ray flux from the pre-patient collimator that affects the signal detected on the X-ray detector after transmission through a subject in an X-ray beam path.

Another aspect that impacts the measurement quality of the X-ray detector signal, given a constant input X-ray flux from the pre-patient collimator, may be attributable to the differential transmission losses after the X-ray beam passes through the subject.

Furthermore, the pre-patient collimator being the X-ray attenuator can start impacting the spectrum of the X-ray emanating from the X-ray tube and this may lead to beam-hardening prior to passage through the subject differently impacting only the X-ray detector rows that may be in an umbra-penumbra transition region. This impact may be directly proportional to the ratio of an umbra transition region to a penumbra transition region and also the material properties of the pre-patient collimator prior to passage through the subject.

The combined impact of the system exposure parameters, pre-patient collimator on the X-ray photon flux and the spectrum, along with the differential tissue attenuation properties of the subject, impact the signal quality on the X-ray detector rows that see the umbra-penumbra region at the outermost envelope of the collimation differentially as compared to the central rows of exposure. This may lead to image quality differences if not appropriately managed during the acquisition.

The present disclosure may enable blocking of X-rays in non-imaging regions. The present disclosure enables the pre-patient collimator to actively participate in dose management techniques within a set collimation for a particular scan coverage, independently or in conjunction. The present disclosure may also enable the adjustment of the dose efficiency based on the clinical conditions or patient-specific models, which may allow the CT imaging system to realize a balance between the image quality and the X-ray dose.

### SUMMARY

This summary introduces concepts that are described in more detail in the detailed description. It should not be used to identify essential features of the claimed subject matter, nor to limit the scope of the claimed subject matter.

In an aspect, a system includes a computing device electrically coupled to a collimator and an X-ray detector. The computing device includes at least one processor in communication with at least one memory device, and at least one processor programmed to select an X-ray dose efficiency based on one or more parameters, and dynamically configure a collimator aperture of the system within a reliability range of a calibration curve based on the selected X-ray dose efficiency and an X-ray flux measured by the X-ray detector.

In another aspect, a computer-implemented method includes selecting an X-ray dose efficiency for a collimation process; searching an operating point, by a processor, within a reliability range, dynamically configuring a collimator aperture, by the processor, based on selected the X-ray dose efficiency prior to a scan, and implementing the collimator aperture, by the processor, during an X-ray exposure.

### BRIEF DESCRIPTION OF DRAWINGS

Various aspects of this disclosure may be better understood upon reading the detailed description with reference to the accompanying drawings.

FIG. 1 is a perspective diagram of a computed tomography (CT) imaging system in accordance with an embodiment.

FIG. 2 is a schematic block diagram of a CT imaging system in accordance with an embodiment.

FIG. 3 is a pictorial view of an X-ray source, a pre-patient collimator, and an X-ray detector array of a CT imaging system in accordance with an embodiment.

FIG. 4 is a schematic block diagram of a control system to dynamically configure a pre-patient collimator aperture in accordance with an embodiment.

FIG. 5 illustrates an exemplary calibration curve depicting a plurality of operating points for a pre-patient collimator in accordance with an embodiment.

FIG. 6 illustrates a graphical illustration of different widths of an X-ray beam for the operating points of a pre-patient collimator in accordance with an embodiment.

FIG. 7 illustrates a flow diagram for a computer-implemented method to select an operating point for a pre-patient collimator in accordance with an embodiment.

FIG. 8 illustrates a computer-implemented method of searching an operating point of a of a pre-patient collimator in accordance with one or more embodiment.

### DETAILED DESCRIPTION

Embodiments of the present disclosure will now be described, by way of example, with reference to the Figures in the accompanying drawings. In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized, and that logical, mechanical, electrical, and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various examples of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As used herein, the term “computer” and related terms, e.g., “computing device”, “computer system” “processor”, “controller” are not limited to integrated circuits referred to in the art as a computer, but broadly refers to at least one microcontroller, microcomputer, programmable logic controller (PLC), application specific integrated circuit, and other programmable circuits, and these terms are used interchangeably herein.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “systems”, “devices” and “apparatuses are interchangeable and include components, sub-components, sub-systems that include without limitation, the medical imaging devices.

While certain examples are described below in the context of medical or healthcare systems, other examples can be implemented outside the medical environment.

A system may be provided to dynamically configure a collimator aperture of a CT imaging system. The system may provide a computing device electrically connected to a collimator and an X-ray detector. The computing device comprising at least a processor in communication with at least a memory device. The processor may be programmed to select an X-ray dose efficiency based on one or more parameters and dynamically configure a collimator aperture of the system within a reliability range of a calibration curve based on selected X-ray dose efficiency and an X-ray flux measured by the X-ray detector.

A computer-implemented method may be provided to dynamically configure the collimator aperture of the CT imaging system. In an aspect of the disclosure, the computer-implemented method may provide selecting an X-ray dose efficiency for a collimation. In an aspect of the disclosure, the computer-implemented method may provide searching an operating point, by a processor, within a reliability range. In an aspect of the disclosure, the computer-implemented method may provide dynamically configuring a collimator aperture, by the processor, based on selected X-ray dose efficiency using a scaling coefficient and X-ray flux measured by an X-ray detector.

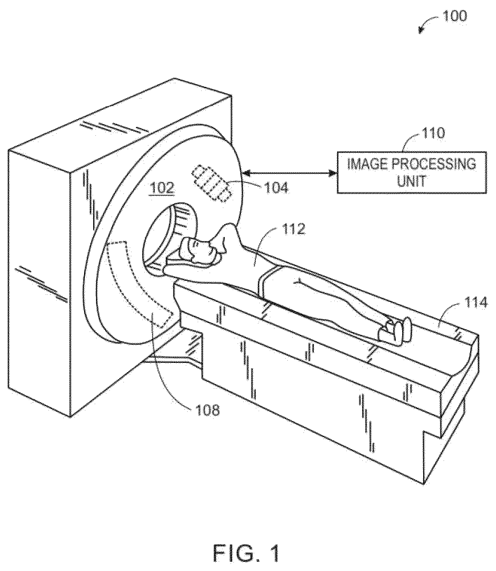

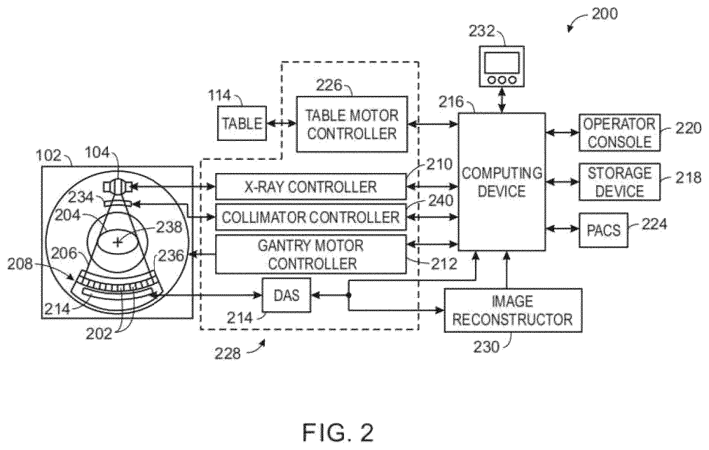

FIG. 1 illustrates a perspective diagram of a CT imaging system. Particularly, the CT imaging system 100 is configured to image a subject 112 such as a patient, an inanimate object, one or more manufactured parts, and/or foreign objects such as dental implants, stents, and/or a contrast agent present within the body. In an embodiment, the CT imaging system 100 includes a gantry 102, which in turn, may further include at least one X-ray source or X-ray tube 104 configured to project a beam of X-ray radiation 206 (see FIG. 2) for use in imaging the subject 112 laying on a table 114. Specifically, the X-ray source 104 is configured to project the X-ray radiation beams 206 towards an X-ray detector 208 positioned on the opposite side of the gantry 102. Although FIG. 1 depicts only a single X-ray source 104, in certain examples, multiple X-ray sources and X-ray detectors may be employed to project a plurality of X-ray radiation beams 206 for acquiring projection data at different energy levels corresponding to the patient. In some examples, the X-ray source 104 may enable dual-energy spectral imaging by rapid peak kilovoltage (kVp) switching. In some examples, the X-ray detector employed is a photon counting X-ray detector which is capable of differentiating X-ray photons of different energies. In other examples, two sets of X-ray sources and X-ray detectors are used to generate dual-energy projections, with one set at low kVp and the other at high kVp. It should thus be appreciated that the methods described herein may be implemented with single energy acquisition techniques as well as dual energy acquisition techniques.

In some CT imaging system configurations, an X-ray source projects a cone-shaped X-ray radiation beam which may be collimated to lie within an X-Y-Z plane of a Cartesian coordinate system and generally referred to as an “imaging plane.” The X-ray radiation beam passes through an object being imaged, such as the patient or subject. The X-ray radiation beam, after being attenuated by the object, impinges upon the X-ray detector. The intensity of the attenuated X-ray radiation beam received at the X-ray detector may be dependent upon the attenuation of the radiation beam by the object. The X-ray detector may produce an electrical signal indicative of measurement of the X-ray beam attenuation at the X-ray detector. The attenuation measurements from the X-ray detector may be acquired separately to produce a transmission profile.

FIG. 2 illustrates a schematic block diagram of a CT imaging system 200. The imaging system 200 may be configured for imaging a subject 204 (e.g., the subject 112 of FIG. 1). In an example, the imaging system 200 includes the X-ray detector 208 (see FIG. 2). The X-ray detector 208, further, may include an array of X-ray detectors having a plurality of X-ray detector elements 202 that together sense the X-ray radiation beam 206 that pass through the subject 204 (such as a patient) to acquire corresponding projection data.

Accordingly, in one example, the X-ray detector 208 may be fabricated in a multi-slice configuration including the plurality of rows of cells or X-ray detector elements 202. In such a configuration, one or more additional rows of the X-ray detector elements 202 are arranged in a parallel configuration for acquiring the projection data.

The imaging system 200 may be configured to traverse different angular positions around the subject 204 for acquiring desired projection data. Accordingly, the gantry 102 and the components mounted thereon may be configured to rotate about a center of rotation 216 for acquiring the projection data, for example, at different energy levels. Alternatively, in an example where a projection angle relative to the subject 204 varies as a function of time, the mounted components may be configured to move along a general curve rather than along a segment of a circle.

As the X-ray source 104 and the X-ray detector 208 rotate, the X-ray detector 208 collects data of the attenuated X-ray beams. The data collected by the X-ray detector 208 undergoes pre-processing and calibration to condition the data to represent the line integrals of the attenuation coefficients of the scanned subject 204. The processed data are commonly called projections.

The individual X-ray detectors or X-ray detector elements 202 of the X-ray detector 208 may include photon counting X-ray detectors which register the interactions of individual photons into one or more energy bins. It should be appreciated that the methods described herein may also be implemented with energy-integrating X-ray detectors.

The imaging system 200 includes a control mechanism 228 to control movement of the components such as rotation of the gantry 102 and the operation of the X-ray source 104. In certain aspect of the disclosure, the control mechanism 228 further includes an X-ray controller 210 configured to provide power and timing signals to the X-ray source 104. Additionally, the control mechanism 228 includes a gantry motor controller 212 configured to control a rotational speed and/or position of the gantry 102 based on imaging requirements.

The control mechanism 228 further includes a data acquisition system (DAS) 214 configured to sample analog data received from the X-ray detector elements 202 and convert the analog data to digital signals for subsequent processing. The DAS 214 may be further configured to selectively aggregate analog data from a subset of the X-ray detector elements 202. The data sampled and digitized by the DAS 214 may be transmitted to a computer or computing device 216. In one example, the computing device 216 stores the data in a storage device or mass storage 218. The storage device 218, for example, may include a hard disk drive, a floppy disk drive, a compact disk-read/write (CD-R/W) drive, a Digital Versatile Disc (DVD) drive, a flash drive, and/or a solid-state storage drive.

Additionally, the computing device 216 provides commands and parameters to one or more of the DAS 214, the X-ray controller 210, and the gantry motor controller 212 for controlling system operations such as data acquisition and/or processing. The computing device 216 controls system operations based on operator input. The computing device 216 receives the operator input, for example, including commands and/or scanning parameters via an operator console 220 operatively coupled to the computing device 216. The operator console 220 may include a keyboard (not shown) or a touchscreen to allow the operator to specify the commands and/or scanning parameters.

Although FIG. 2 illustrates only one operator console 220, more than one operator console may be coupled to the CT imaging system 200, for example, for inputting or outputting system parameters, requesting examinations, plotting data, and/or viewing images. Further, in certain examples, the imaging system 200 may be coupled to multiple displays, printers, workstations, and/or similar devices located either locally or remotely, for example, within an institution or hospital, or in an entirely different location via one or more configurable wired and/or wireless networks such as the Internet and/or virtual private networks, wireless telephone networks, wireless local area networks, wired local area networks, wireless wide area networks, wired wide area networks, etc.

In an example, the imaging system 200 either includes, or is coupled to, a picture archiving and communications system (PACS) 224. In an exemplary implementation, the PACS 224 is further coupled to a remote system such as a radiology department information system, hospital information system, and/or to an internal or external network (not shown) to allow operators at different locations to supply commands and parameters and/or gain access to the image data.

The computing device 216 uses the operator-supplied and/or system-defined commands and parameters to operate a table motor controller 226, which in turn, may control a table 114 which may be a motorized table. Specifically, the table motor controller 226 may move the table 114 for appropriately positioning the subject 204 in the gantry 102 for acquiring projection data corresponding to the target volume of the subject 204.

The various methods and processes described further herein may be stored as executable instructions in non-transitory memory on a computing device (or controller) in imaging system 200. In one example, the computing device 216 may determine the characterization of the X-ray tube. In another example, computing device 216 may include the instructions in non-transitory memory, and may apply the methods described herein, at least in part, to the acquired data for characterization of the X-ray tube. In CT imaging system 100, when the gantry 102 being rotated, the gantry 102 may be rotated 360 degrees for N times to generate N projections.

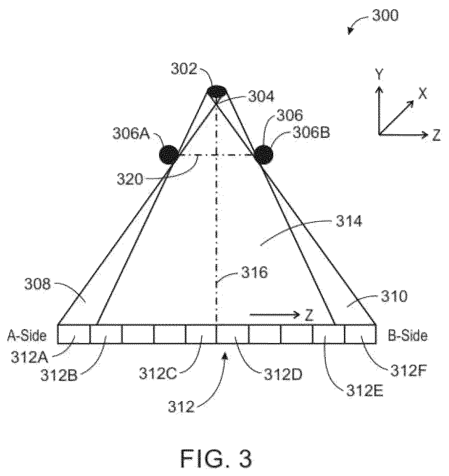

FIG. 3 illustrates an X-ray source 302, a pre-patient collimator 320, and an X-ray detector array 312 of a CT imaging system 300 in a z-direction. The X-ray beam 304 may originate from a focal spot 302 of the X-ray source 104 (shown in FIG. 2). The X-ray beam 304 may be collimated by a collimator 306 towards the X-ray detector array 312 for acquiring the projection data.

X-ray detector array 312 may be arranged in a multi-slice (or row) configuration, where the projection data from each X-ray detector row 312A, 312B, 312C, 312D, 312E, and 312F may be used to obtain cross-section slice of the subject. The number of X-ray detector rows 312A, 312B, 312C, 312D, 312E, and 312F shown in FIG. 3 may be used for illustration purposes and not limiting the design or scope of the disclosure. A fan beam plane 316 of the CT imaging system 100 may be aligned to a centerline of X-ray detector array 312, although fan beam plane 316 may not always exactly aligned due to factors such as focal spot movement and gantry vibrations. In a non-limiting example, an inner X-ray detector rows(s) 312C, 312D may refer to the rows closer to the centerline of fan beam plane 316 and an outer X-ray detector row(s) 312A, 312F, may usually refer to the X-ray detector rows at the edge of the slice coverage.

The CT imaging system 100 may include a movable pre-patient collimator, which may be programmable in steps and X-ray detector array 312 including a plurality of X-ray detector elements arranged in rows and columns, the X-ray detector rows may be extending on both sides from the center. The two sides of the X-ray detector array 312 may be referred to as X-ray detector A-side and X-ray detector B-side. The computing device may be coupled to the collimator and X-ray detector array 312. The computing device may be configured to determine a plurality of operating points for a collimator cam for X-ray detector A-side and for X-ray detector B-side while ensuring reliability on the X-ray detector A-side and X-ray detector B-side based on the geometry of the CT imaging system 100. The operating points for the X-ray detector A-side and X-ray detector B-side may be selected based on a patient specific model or clinical conditions during real-time scanning.

A system may optimally estimate a set of operating points that control the aperture or collimation of a pre-patient collimator and thereby enabling the trade-off between dose exposure to the subject and the image quality to make customizable as per the clinical requirements having various dose-sensitivity and image quality, optimization of the aperture based on the subject and thereby may provide a unique set of operating conditions for each and every subject. Even within a single scan from the multiple projections of data acquisition in a tomography scan on a single subject various operating conditions may be configured.

In another non-limiting example, the outer X-ray detector rows 312A, 312F may be selected to serve as z-position X-ray detectors of the X-ray beam 304. In another non-limiting example, the outer X-ray detector rows 312A, 312F may be selected to be at least substantially within a penumbra region 308, 310 of the X-ray beams 304 whereas inner X-ray detector rows 312C, 312D may be selected to be at least substantially within an umbra region 314 of the X-ray beam 304. In another non-limiting example, the inner row X-ray detectors 312C, 312D may be taken as a reference against which the outer row X-ray detectors 312A, 312F as the signals generated from the outer row X-ray detectors 312A, 312F depends on the X-ray beam intensity and hence the z-position of the X-ray beam 304. In a non-limiting example, the collimator 306 may contain tapered cams 306A, 306B. In another embodiment, the collimator 306 may comprise cams without any taper and cams with fixed slots.

Each respective cam, 306A, 306B may be independently programmed and controlled by the X-ray controller 228 (FIG. 2) to alter the width and the position of the X-ray beam umbra 314 relative to the edge of the X-ray detector rows 312A, 312B and 312E, 312F. The focal spot 302 may move away from its nominal position, which may require the movement of the cams 306A, 306B along with the collimator 306 to ensure that the newly moved position of the focal spot 302 may continue to remain focused on the X-ray detector array 312.

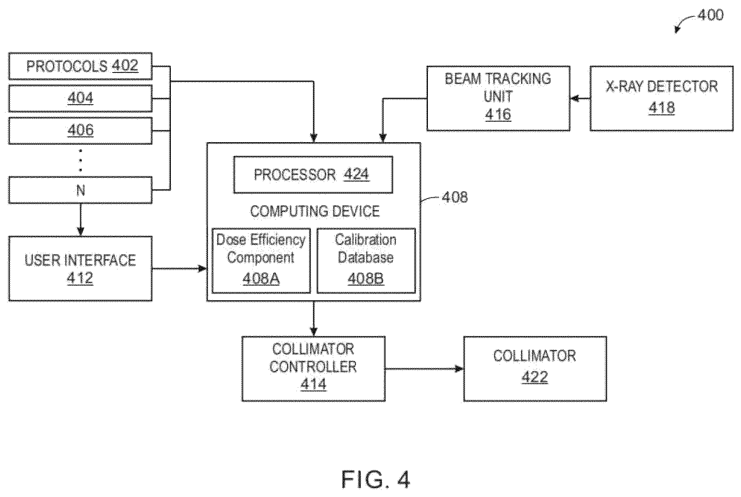

FIG. 4 illustrates a schematic block diagram 400 of a control system 408 to dynamically configure a pre-patient collimator aperture, including a control system to demonstrate a dose efficiency component 408A. The proposed dose efficiency component 408A may be a system for a real-time control of dose efficiency of the CT imaging system 100 based on a selectable protocol 402, 404, 406. In a non-limiting example, the protocols 402, 404, 406 may be displayed on a display screen and in another non-limiting example, the protocols 402, 404, 406 may be accessible in form of one or more switch buttons. A user interface 412 may enable a user to select an X-ray dose efficiency by selecting a protocol 402, 404, 406 from a scout scan. A scout scan is a low dose two-dimensional (2D) scan used to help a CT technologist position a patient for imaging and define the scan range of a subsequent CT diagnostic scan.

The protocols 402, 404, 406 may be customized primarily to enable a finer control of dose efficiency. The select protocol 402, 404, 406 may be communicated to a computing device 408.

The select protocol 402, 404, 406 may be communicated to the computing device 408 and further processed by a dose efficiency component 408A to obtain a desired operating point using information provided by a calibration database 408B. The calibration database 408B may store the data related to the calibration of the collimator, which may be pre stored, in a non-limiting example or in another limiting example, the calibration database 408B may be populated after collecting data related to the X-ray flux on the X-ray detector 312.

The dose efficiency component 408A may be visualized as a part of the computing device 408 in a non-limiting example, however, in another non-limiting example, dose efficiency component 408A may be implemented as a standalone component within a beam tracking unit 416 or a collimator aperture controller 414. The output of the dose efficiency component 408A may be received by the collimator 422 followed by collimator aperture controller 414 which controls the actuator thereby controlling the position of the cams 306 (shown in FIG. 3).

The X-ray flux measured by the X-ray detector 418 over at least one X-ray detector row (as shown in FIG. 3) may be provided to a beam-tracking unit 416 to determine the width and position of the X-ray beam. The beam-tracking 416 unit may rely on the umbra-penumbra transition to estimate the position of the X-ray beam on the X-ray detector A-side and X-ray detector B-side. The focal spot 302 (shown in FIG. 3) may undergo continuous z-direction movements due to factors such as a thermal expansion due to X-ray production, vibrations due to an anode rotor rotation, and gravitational centripetal forces due to the gantry rotation. The X-ray beam may move due to focal spot movement and the beam-tracking unit 416 may detect the same and may provide real-time feedback to the cam 306 (shown in FIG. 3) through the computing device 408. In a non-limiting example, the dose efficiency component 408A may adjust the width of the X-ray beam in addition to the beam position adjustments performed by the beam-tracking unit 416.

In a non-limiting example, the CT imaging device may be integrated to the computing device 408 and in another non-limiting example, the CT imaging device may be a standalone unit, which may be connected to the computing device 408 electrically or wirelessly.

The computing device 408 may be configured to receive an input from a user interface 412. The user interface 412 may be an input device, which may enable a user to select a protocol 402, 404, 406. In a non-limiting example, the protocols 402, 404, 406 may be displayed on a display screen and in another non-limiting example, the protocols 402, 404, 406 may be accessible in form of one or more switch buttons. The user interface 412 may enable a user to optimize an X-ray dose efficiency and image quality by selecting a protocol 402, 404, 406. The calibration database 408B may store the data related to the calibration of the collimator, which may be pre stored, in a non-limiting example or in another limiting example, the calibration database 408B may be populated after collecting data related to the X-ray flux on the X-ray detector rows 312A, 312C (shown in FIG. 3).

The dose efficiency component 408A may be visualized as a part of the computing device 408 in a non-limiting example, however, in another non-limiting example, dose efficiency component 408A may be implemented as a standalone component within a beam tracking unit 416 or a collimator aperture controller 414.

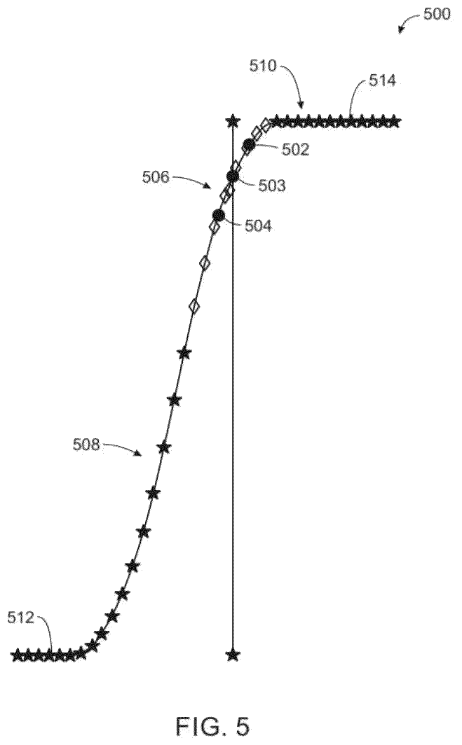

FIG. 5 illustrates a calibration curve 500 with an operating point selection of a pre-patient collimator. The Calibration curve 500 may be obtained for the X-ray detector A-side using the ratio of X-ray flux between row 312C and 312A (refer to FIG. 3) over the entire set of possible cam positions. This calibration process captures the variation of the X-ray flux in the outer row 312A from no flux 512 to full flux 510 through the umbra-penumbra transition 508. In the transition region 508, in a non-limiting example, there may exists a region of operation 506 for a required collimation where an operating point, say 503, may be fixed which may be translated to a desired X-ray beam width thereby providing a fixed dose efficiency.

In another non-limiting example, there may be an operating point 504 which translates to an X-ray beam width to increase the dose efficiency compared to operating point at 503 while reducing the flux on the X-ray detector edge rows thereby reducing the image quality on the edge rows. In another non-limiting example, there may be an operating point 502 which translates to an X-ray beam width to decrease the dose efficiency compared to 503 while increasing the flux on the X-ray detector edge rows thereby increasing the image quality. The operating point selection may the width of the X-ray beam, dose efficiency, the x-flux, and hence the image quality.

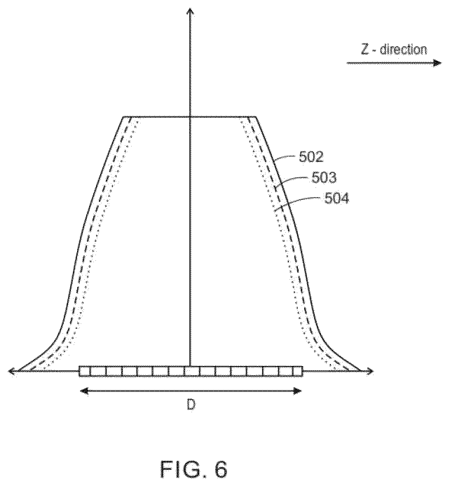

FIG. 6 illustrates a graphical illustration of different widths of an X-ray beam for the operating points 502, 503, and 504 of a pre-patient collimator shown in FIG. 5. The estimation of the operating points 502, 503, and 504 may be a function of the dose efficiency selected by the user based on clinical needs of the subject and/or in conjunction with the image quality need. After selecting the protocol to set the dose efficiency, the dose efficiency component 408A may compute the collimation aperture needed to achieve the requested dose efficiency that may be defined as the ratio of requested collimation over the realized collimation for a scan process. The dose efficiency component 408A may restrict the operating point selection to be within the reliable range 506 (refer to FIG. 5) while trying to accommodate the setting for the aperture based on the dose efficiency requested by the user. This may enable desired operating points that provide the requested dose efficiency while ensuring reliable beam-tracking for desired image quality during a scan.

The estimation of the operating points may be a function of the user's requirement to optimize image quality as a primary request as opposed to dose efficiency. In such a scenario the dose efficiency component 408A may compute the collimation aperture needed to achieve the maximum aperture opening possible to provide improved signal due to increased flux while ensuring the operating points may still enable reliable beam-tracking during a scan.

The user may configure for an image quality to keep the dose to a minimum level as per the ALARA principle. In this case, an additional input of a model describing the subject can be taken in as an auxiliary input to the Dose Efficiency Component 408A. The input could be an X-ray scout scan with low-dose X-ray exposure taken at a single or multiple angles of projection to create a combination of multi-angle two-dimensional projections, in a non-limiting example or a limited angle three-dimensional (3D) tomographically reconstructed model of the subject in another non-limiting example. In another non-limiting example, an auxiliary input may be a model of the subject constructed from one or more sensors that may be available in the form of a plurality of images taken from multiple angles on in another non-limiting example, the auxiliary input may be pre-processed depth map that may provide a three-dimensional model representation of the subject. Furthermore, the sensor may include an optical sensor, a camera in visible range, an infrared camera, a LiDAR (Light Detection and Ranging), a terahertz imaging system, an RF (Radio frequency) radar in an electromagnetic spectrum, and a non-electromagnetic spectrum including acoustic, ultrasonic radar-based depth sensor.

The resultant model that may be provided as an auxiliary input may be utilized by the Dose Efficiency Component 408A to create a possible path length model at every possible projection angle that might be acquired during a tomographic acquisition. This may allow the system to predict the flux requirement to ensure stable measurements at the X-ray detector to manage or modulate the aperture to ensure good measurements at the X-ray detector. This may be done as a single aperture estimation per subject prior to a scan or compute view-by-view or per-projection angle aperture within one scan of a single subject. Such a method of selection of the operating points may provide the possibility of keeping the dose exposure to a minimum while ensuring image quality that is specifically optimized to a particular subject. This provides for a system to not only optimize the dose efficiency and image quality based on user requirements, but additionally provide automatically computed operating points to give intelligent subject-adaptive settings.

According to an aspect of the disclosure, the system may dynamically select the operating point given a particular criterion. Assume that the operating point gives an X-ray width d, the dose efficiency component modulates the scaling coefficient α to obtain a revised beam width dᵣ=d+αΔ, where Δ is the size of the focal spot 302 in the z-direction. The system parameter Δ may also be based on any relevant parameter from the CT system geometry but not only limited to focal spot.

The scaling coefficient α may be discretized rational value and determined by the dose efficiency component either before or during the scan in real-time. In a non-limiting example, the scaling factor may be determined based but not limited to the selected clinical protocol, patient-specific data like a scout scan, or input by clinician or user into the user-interface of the system.

The system may enable the control of the X-rays based on the selection of the X-ray dose efficiency within the reliability range.

The calibration curve 500 comprises a dark range 508, a bright range 510 and a reliability range 506, wherein the dark range 508 may lie in between a lowest level 512 of the calibration curve 500 and a favorable dose position 504, wherein the bright range 510 may lie in between a highest level 514 of calibration curve 500 and a favorable image quality position 502.

In an example, the collimator aperture may be controlled by a scaling coefficient, wherein the scaling coefficient may be configured to be restricted within a range set by a system geometry of the CT imaging system and a reliability range 506 of the CT imaging system; wherein a lowest value of the scaling coefficient may be restricted by the system geometry and a highest value of the scaling coefficient may be restricted by the reliability range. The scaling coefficient and the reliability range 506 may be configured for each collimation process to generate a required Image quality.

In a non-limiting example, the reliability range 506 may comprise a desired position 503 which may lie in-between of the favorable image quality position 502 and the favorable dose position 504, wherein the reliability range 506 may be the curve formed between the favorable image quality position 502 and the favorable dose position 504. The reliability range 506 is a region of operation for a required collimation, where the desired point 503 may be fixed, which may be a desired x-ay beam width thereby providing a fixed dose efficiency.

In a non-limiting example, the favorable dose position 504 which may translate to an X-ray beam width to increase the dose efficiency compared to the desired position 503 while reducing the flux on the X-ray detector edge rows.

In a non-limiting example, the favorable image quality position 502 which may translate to an X-ray beam width to decrease the dose efficiency compared to desired position 503 while increasing the flux on the X-ray detector edge rows. Thus, the operating point selection affects the width of the X-ray beam, dose efficiency, the X-ray flux, and the image quality.

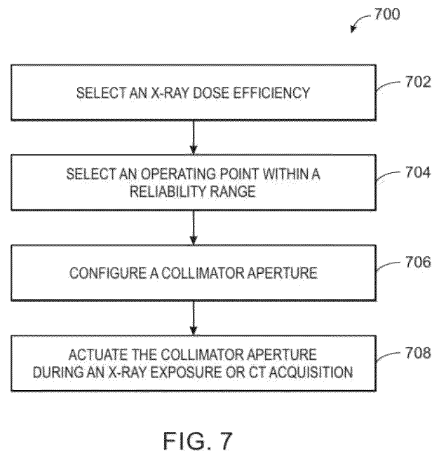

FIG. 7 illustrates a flow diagram for a computer-implemented method to select an operating point for a pre-patient collimator of a CT imaging system and improving the dose efficiency. The method may comprise selecting an X-ray dose efficiency for the purpose of collimation process, in step 702. Selecting an X-ray dose efficiency may comprise selecting the X-ray dose based on the subject's requirement, which may be controlled by one or more parameters of a protocol, scout scan, etc.

In a non-limiting example, the selection of the X-ray dose efficiency may be based on protocols available to a user or clinician. The protocol may be selected by a CT technician or user from a user interface 412. In an exemplary embodiment, the user interface 412 may have a memory, which may store the previously selected protocol and in another exemplary embodiment, the user interface 412 may have the capacity to store plurality of selected protocols, which may be accessed or transferred for later use. In an exemplary embodiment, the protocols may include an adult protocol, a pediatric protocol, attenuation profile protocol, a scout scan of the subject, or a dose request protocol. The adult protocol and the pediatric protocol may enable selection of X-ray dose efficiency based on the age of the subject and may help in ensuring that the X-ray dose may not increase beyond a maximum threshold or falls below a minimum threshold. The dose request protocol may enable selection of X-ray dose efficiency based on certain parameters including the collimator aperture, applied voltage and current etc. The dose request protocol may enable a user to select an X-ray dose efficiency, which may be customized e.g., the dose request protocol may be used during emergency cases and the amount of X-ray may be optimized without affecting the image quality, which may reduce the time required to ascertain and narrow down the problem area in the subject's body. The attenuation profile protocol may enable the selection of X-ray dose efficiency based on the attenuation coefficients of a scout scan.

In step 704, the method may enable searching or computing for an operating point, by the processor of the computing device, within a reliability range 506 of the calibration curve 500 based on the selected X-ray dose efficiency. In a non-limiting example, the operating point may be selected for an X-ray detector A-side (left-hand side of the X-ray detector) and in another non-limiting example, the operating point may be selected for an X-ray detector B-side (right-hand side of the X-ray detector). The operating point may be selected for both the halves of the X-ray detector while maintaining reliability and image quality. Once the operating point may get selected, then in step 706, the collimator aperture may be dynamically configured based on the selected X-ray dose efficiency and X-ray flux measured by the X-ray detector for an intra scan using a scaling coefficient, in a non-limiting example and the collimator aperture may be dynamically configured based on the selected X-ray dose efficiency and X-ray flux measured by the X-ray detector for an inter scan using the scaling coefficient. Further, in step 708, the collimator aperture may be implemented during an X-ray exposure acquisition process.

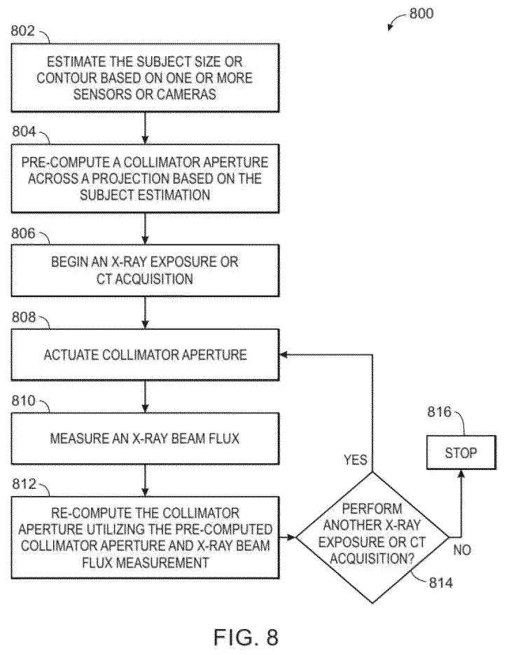

FIG. 8 illustrates a computer-implemented method of searching an operating point of a pre-patient collimator. Step 802 includes measuring the subject based on one or more sensors or a scout scan. In step 804, a pre-computed aperture may be applied cross projections based on the subject model. In step 806, the scanning process may be enabled and a selected collimator aperture may be actuated in step 808. In step 810, the X-ray beam flux may be measured. In step 812, collimator aperture may be re-computed utilizing the pre-computed aperture and X-ray beam flux. In step 814, the system may check for further scanning request from the user and if not, then the scanning process may be stopped in step 816 or otherwise the collimator may be actuated again.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but may not be limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. Respective components can execute from various computer readable media having various data structures stored thereon. The components can communicate via local and/or remote processes such as in accordance with a signal having one or more data packets/data sets (e.g., data from one component interacting with another component in a local system, distributed system, and/or across a network such as the Internet with other systems via the signal). In accordance with another aspect of the disclosure, a component can be an apparatus with specific functionality provided by mechanical parts operated by electric or electronic circuitry, which may be operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In accordance with another aspect of the disclosure, a component can emulate an electronic component via a virtual machine, e.g., within a cloud computing system.

In addition, the term “or” may be intended to mean an inclusive “or” rather than an exclusive “or.” That is, unless specified otherwise, or clear from context, “X employs A or B” may be intended to mean any of the natural inclusive permutations. That is, if X employs A; X employs B; or X employs both A and B, then “X employs A or B” may be satisfied under any of the foregoing instances.

Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein may not be limited by such examples. In addition, any aspect or design described herein as an “example” and/or “exemplary” may not necessarily to be construed as preferred or advantageous over other aspects or designs, nor it may be meant to preclude equivalent exemplary structures and techniques known to those of ordinary skill in the art.

As it may be employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches, and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or non-volatile memory or can include both volatile and non-volatile memory. By way of illustration, and not limitation, non-volatile memory can include read only memory (ROM), programmable ROM (PROM), electrically programmable ROM (EPROM), electrically erasable ROM (EEPROM), flash memory, or non-volatile random-access memory (RAM) (e.g., ferroelectric RAM (FeRAM). Volatile memory can include RAM, which can act as external cache memory, for example. By way of illustration and not limitation, RAM may be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices, and drawings such terms are intended to be inclusive in a manner similar to the term “comprising” as “comprising” may be interpreted when employed as a transitional word in a claim. The descriptions of the various examples have been presented for purposes of illustration but are not intended to be exhaustive or limited to the examples disclosed. Many modifications and variations can be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

This written description uses examples to disclose the invention, including the best mode, and to enable any person skilled in the art to practice the invention, including making and using any computing system or systems and performing any incorporated methods. The patentable scope of the invention may be defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Examples of the present disclosure shown in the drawings and described above are example examples only and are not intended to limit the scope of the appended claims, including any equivalents as included within the scope of the claims. Various modifications are possible and will be readily apparent to the skilled person in the art. It is intended that any combination of non-mutually exclusive features described herein are within the scope of the present invention. That is, features of the described examples can be combined with any appropriate aspect described above and optional features of any one aspect can be combined with any other appropriate aspect. Similarly, features set forth in dependent claims can be combined with non-mutually exclusive features of other dependent claims, particularly where the dependent claims depend on the same independent claim. Single claim dependencies may have been used as practice in some jurisdictions require them, but this should not be taken to mean that the features in the dependent claims are mutually exclusive.

We claim:

1. A system, comprising:
a computing device electrically coupled to a collimator and an X-ray detector, the computing device comprising at least one processor in communication with at least one memory device, and at least one processor programmed to:
selecting an X-ray dose efficiency based on one or more parameters; and
dynamically configuring a collimator aperture of the system within a reliability range of a calibration curve based on the selected X-ray dose efficiency and an X-ray flux measured by the X-ray detector.

2. The system of claim 1, wherein the computing device further comprises a dose efficiency component configured to receive a protocol selected by a user.

3. The system of claim 2, wherein a select protocol is processed by the dose efficiency component to obtain a desired operating point based on a data stored in a calibration database, wherein the calibration database is configured to store the data related to a calibration of the collimator.

4. The system of claim 2, wherein the dose efficiency component is configured to send an output to a collimator aperture controller and adjust a width of an X-ray beam, wherein the collimator aperture controller controls an actuator to change a position of a cam, wherein the cam is connected to collimator aperture controller.

5. The system of claim 2, wherein the dose efficiency component is implemented in a beam tracking unit or a collimator aperture controller.

6. The system of claim 1, wherein the collimator aperture is configurable by a processor within the reliability range of the calibration curve, wherein the reliability range comprises a desired position which lies in between a favorable image quality position and a favorable dose position, wherein the reliability range is a curve formed between the favorable image quality position and the favorable dose position.

7. The system of claim 1, wherein the collimator aperture is controlled by a scaling coefficient, wherein a value of the scaling coefficient is configured to be restricted within a range set by a system geometry and the reliability range of the system; wherein a minimum value of the scaling coefficient is set by the system geometry and a maximum value of the scaling coefficient is set by the reliability range.

8. The system of claim 7, wherein the scaling coefficient and the reliability range are configured for each collimation process to generate a required image quality.

9. The system of claim 1, wherein the X-ray dose efficiency may be further optimized and controlled by one or more parameters including a use-case, a scout scan, wherein the one or more parameters includes a pre-scan data, subject's medical history, a current applied to an X-ray source, a voltage applied across the X-ray source, a helical pitch, and image reconstruction parameters.

10. A computer-implemented method, comprising:
selecting an X-ray dose efficiency for a collimation process;
searching an operating point, by a processor, within a reliability range;
dynamically configuring a collimator aperture, by the processor, based on selected the X-ray dose efficiency prior to a scan; and
implementing the collimator aperture, by the processor, during an X-ray exposure.

11. The computer-implemented method of claim 10, wherein selecting the X-ray dose efficiency comprises selecting a use-case, a scout scan, or one or more parameters.

12. The computer-implemented method of claim 10, wherein the dose efficiency component is configured to receive a model of the subject, wherein the model describes properties of the subject as an auxiliary input in order to estimate a desired operating point and the collimator aperture.

13. The computer-implemented method of claim 10, wherein a model of a subject is constructed from one or more sensors based on electromagnetic spectrum including an optical sensor, a camera, an infrared camera, a LiDAR, a terahertz imaging system, a RF (Radio frequency) radar, and/or an acoustic system including an ultrasonic depth radar.

14. The computer-implemented method of claim 10, wherein one or more sensor inputs are processed by the computing device to determine a property of the subject including a depth map, wherein the depth map determines an attenuation of X-rays due to the subject to determine an operating point.

15. The computer-implemented method of claim 10, wherein a selection of a particular dose efficiency is based on selection of a use-case including an adult protocol, pediatric protocol, and a dose request protocol.

16. The computer-implemented method of claim 10, wherein searching the operating point comprises:
measuring a subject using one or more sensors or scout scan;
pre-computing the collimator aperture across a set of projections based on the subject;
enabling a scanning process;
enabling an actuating device/collimator;
measuring an X-ray beam flux; and
re-computing the collimator aperture by using a pre-computed collimator aperture and the X-ray beam flux.

17. The computer-implemented method of claim 10, wherein the collimator aperture is dynamically configured separately for an intra scan and for an inter scan.

18. The computer-implemented method of claim 10, wherein a computed operating point configures the collimator aperture within a single scan as a function of projection angle of view.
